(19) United States
(12) Patent Application Publication
(10) Pub. No.: US 2003/0142008 A1
(43) Pub. Date: Jul. 31, 2003

(54) Experimental arrangements for measuring propagation speed of variational gravitational field

(76) Inventor: Guanghua Huang, Prior Lake, MN (US)

Correspondence Address: MERCHANT & GOULD PC, P.O. BOX 2903, MINNEAPOLIS, MN, 55402-0903, US

(21) Appl. No.: 10/355,407

(22) Filed: Jan. 31, 2003

Related U.S. Application Data
(63) Continuation of application No. 10/066,389, filed on Feb. 1, 2002, now abandoned.
Application No. 10/066,389 is a continuation-in-part of application No. 09/520,234, filed on Mar. 7, 2000, now abandoned.

(51) Int. Cl. G01S 13/08

(52) U.S. Cl. 342/104

(57) ABSTRACT

One aspect of the invention is a method of measuring the speed at which a variational gravitational field propagates. The gravitational field relates to a planet, and the planet has object of sufficient mass to change the gravitational field. The method comprises: moving a satellite in orbit around the planet so that it passes over the object; determining the distance L_{g} that a satellite travels from a predetermined position and a second position that coincides with the moment that the velocity of the satellite changes from the velocity that the satellite was traveling at the predetermined position due to a change in the gravitational field; determining the distance Lₑₘ that the satellite travels from the predetermined position to a third position that coincides with the moment that an electromagnetic signal to completes travel from the object to the satellite; and calculating the speed of the gravitational field according to the equation:

$${v}_{g} = c \frac{{L}_{em}}{{L}_{g}}$$

where v_{g} is the speed at which the gravitational field travels and c is the speed of light.

### REFERENCE TO CO-PENDING APPLICATION

The present application is a continuation-in-part of commonly owned U.S. patent application Ser. No. 09/520,234, filed on Mar. 7, 2000.

### TECHNICAL FIELD

The present invention relates to instrumentation and experimental arrangements, and more particularly, to apparatuses and methods for measuring the propagation speed of a variational gravitational field.

### BACKGROUND

For nearly a century, physicists have determined that the speed of light is the fastest speed in the universe. Scientists base this determination on Albert Einstein's theory of general relativity, which predicts that mass will become infinite if an object travels at the speed of light.

However, observation of planetary masses notes that the forces from gravitational fields help hold together our universe. These forces hold planets together and they hold objects on planets. Gravitational forces also cause planets to move along defined orbits or paths within our galaxies and affect the relative positioned between galaxies themselves regardless the enormous distance.

Furthermore, these forces appear to work instantaneously. Drop an object and it immediately falls to earth. Pass a satellite orbiting the earth over a mountain peak and its speed will instantly change with the distance between the center of the planet and the surface of the mountain.

A question that this apparently instantaneous reaction raises is whether the propagation speed of the variational gravitational field is faster than the speed of light, which has long been presumed to be the fastest speed in the universe. If the propagation speed of the variational gravitational field is faster than the speed of light, this discovery could have many far reaching implications, practical as well as theoretical. For example, it may provide a basis for developing new and faster forms of communication.

Accordingly, there is need for an apparatus and method to measure the propagation speed of a variational gravitational field.

### SUMMARY

One aspect of the invention is a method of measuring the speed at which a variational gravitational field propagates. The gravitational field relates to a planet, and the planet has object of sufficient mass to change the gravitational field. The method comprises: moving a satellite in orbit around the planet so that it passes over the object; determining the time interval Δt_{g} between a predetermined time and the moment that the velocity of the satellite changes due to a change in the gravitation field; determining the time interval Δtₑₘ it takes an electromagnetic signal to travel from the object to the satellite, the electromagnetic signal beginning to travel at the predetermined time; and calculating the speed of the variational gravitational field according to the equation:

$${v}_{g} = c \frac{Δ {t}_{em}}{Δ {t}_{g}}$$

where v_{g} is the speed at which the gravitational field travels and c is the speed of light.

One possible alternative aspect of the present invention is a method comprising: moving a satellite in orbit around the planet so that it passes over the object; determining the distance L_{g} that a satellite travels from a predetermined position and a second position that coincides with the moment that the velocity of the satellite changes from the velocity that the satellite was traveling at the predetermined position due to a change in the gravitation field; determining the distance Lₑₘ that the satellite travels from the predetermined position to a third position that coincides with the moment that an electromagnetic signal to completes travel from the object to the satellite; and calculating the speed of the variational gravitational field according to the equation:

$${v}_{g} = c \frac{{L}_{em}}{{L}_{g}}$$

where v_{g} is the speed at which the gravitational field travels and c is the speed of light.

### DESCRIPTION OF THE DRAWINGS

FIG. 1 illustrates the experimental setup for measuring gravity field speed.

FIG. 2 is a block diagram of a remote gravitational imaging arrangement illustrated in FIG. 1.

FIG. 3 is the block diagram of the remote Doppler radar imaging arrangement illustrated in FIG. 1.

### DETAILED DESCRIPTION

Various embodiments of the present invention, including a preferred embodiment, will be described in detail with reference to the drawings wherein like reference numerals represent like parts and assemblies throughout the several views. Reference to the described embodiments does not limit the scope of the invention, which is limited only by the scope of the appended claims.

In general terms, the present invention relates to an experimental setup and method for measuring the speed of propagation for a variational gravitational field. A satellite, carrying an electromagnetic imaging device, orbits a planet and passes over an object on the planet. A mountain is an example of such an object. The electromagnetic imaging device transmits an electromagnetic signal toward the mountain and detects the reflected signal. Additionally, the velocity (and changes in the velocity) of the satellite is measured as it passes over the object. The velocity of the satellite as it reacts to gradients or changes in the gravitational field is measured. Data related to propagation of the electromagnetic signal is compared to data related to the velocity of the satellite to determine the speed at which the variational gravitational field propagates.

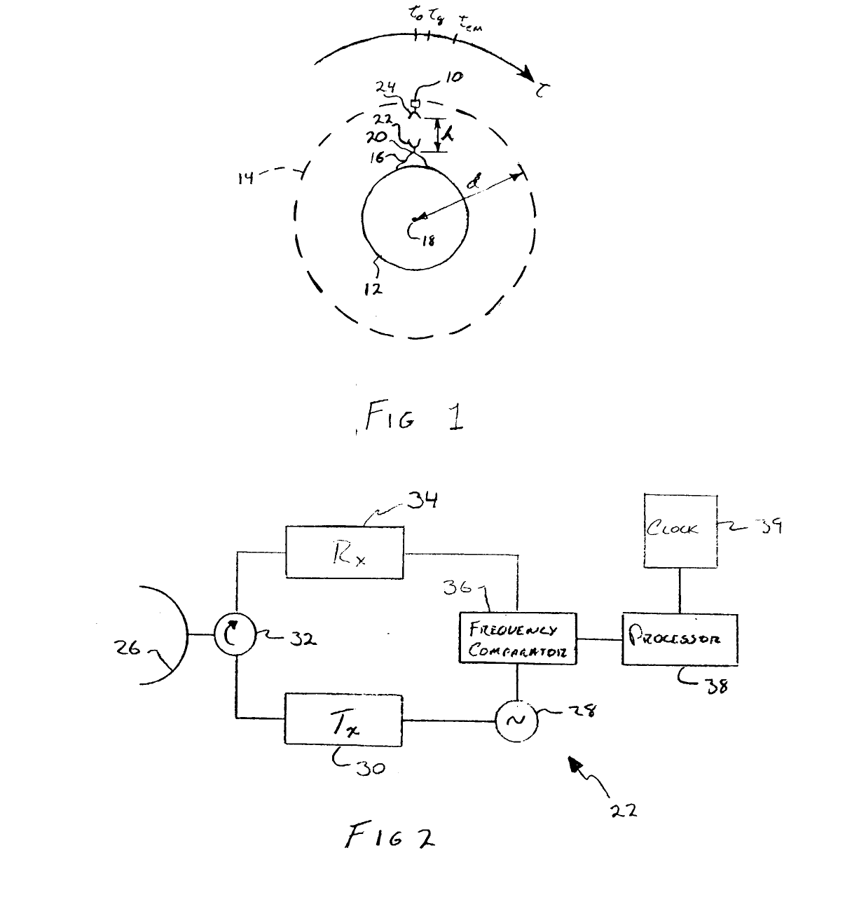

Referring now to FIG. 1, an electromagnetic imaging (EM) satellite 10 orbits the earth 12 along a path 14 and at a constant velocity v. A mountain 16 is located on the earth 12. The earth 12 has a center 18, and the distance 20 from the center 18 of the earth 12 to the path 14 is a predetermined and constant distance d. The path 14 of the satellite 10 passes over the mountain 16. Although the earth 12 and a mountain 16 are discussed herein, any planetary mass or similar structure can be used in place of the earth. Additionally, any object that has enough mass to affect the speed of an orbiting satellite 10 can be used in place a mountain. Furthermore, the satellite 10 can be any structure that is capable of orbiting the earth 12. Examples include both manned an unmanned spacecraft.

As the satellite 10 moves along the path 14, the strength of the gravitational fields to which it is subject will change depending on the terrain of the earth 12. As the distance between the center 18 and the earth's surface increase, the strength of the gravitational field will increase. Similarly, as the distance between the center 18 and the earth's surface decreases, the strength of the gravitational field will decrease. As a result, the velocity of the satellite 10 will have to change to maintain the constant distance between the satellite 10 and the center 18 of the earth 12. To repel the gravitational field as the satellite 10 passes over the mountain 16, the velocity of the satellite 10 will have to increase as it travels toward the mountain's peak 20. Similarly, to increase the effect of the gravitational field, the velocity of the satellite 10 will have to decrease as it travels away from the peak 20.

The gravitational interaction between the satellite 10 and the earth 12, and hence changes in the velocity of the satellite 10, happens within a very short time period. This interaction time is the variational gravity field propagation time (VGFPT). A Doppler radar 22 is mounted on the peak 20 of the mountain 16 and is used to measure the velocity of the satellite 10 as it passes over the mountain 16. The electronics associated with the Doppler radar 22 generates data related to change in the velocity of the satellite 10 and the time at which the change occurs. This data is similar to the data used to create a slice image of the mountain 16.

An EM radar 24 is mounted on the satellite 10. The EM radar 24 emits a signal to the mountain peak 20. The signal is reflected off the mountain peak 20 and the reflected signal is detected by the EM radar 24. The electronics in the satellite 10 records the time lapse between when the original signal is emitted from the EM radar 24 and the reflected signal is received by the EM radar 24.

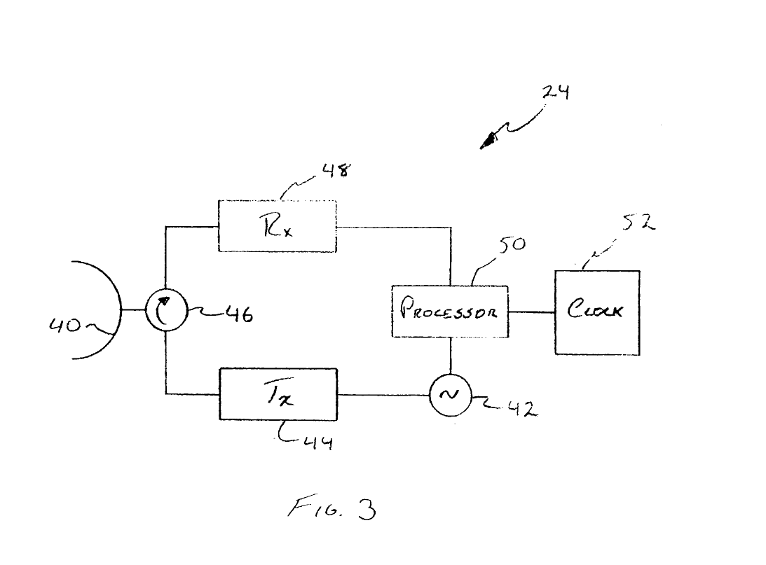

Referring to FIG. 2, the Doppler radar 22 includes an antenna 26 aimed toward the satellite 10. A signal source 28, such as a signal generator, generates a signal that is fed to a transmitter 30, fed through a circulator 32, and sent to the antenna 26. The signal excites the antenna 26, which emits the signal toward the satellite 10. The signal reflects off the satellite 10, and the reflected signal is received at and excites the antenna 26. The reflected signal is then fed back though the circulator 32, through a receiver 34, and fed to a frequency comparator 36.

The comparator 36 compares the reflected signal to the original signal generated by the signal generator 28. The comparator 36 generates an information signal that is indicative of the frequency shift between the reflected signal and the original signal transmitted by the antenna 26. This frequency shift results from the Doppler effect of the moving satellite 10. The information signal is input to a processor 38, which calculates the velocity of the satellite 10.

Additionally, a clock 39 inputs a clocking signal to the processor 38. The processor 38 processes the clock input to determine the time lapse Δt_{g} between the predetermined time to and the first moment after to that the velocity of the satellite 10 changes due to a change in the gravitational field. For purposes of the description set forth herein, to occurs when the satellite 10 is positioned directly over the mountain peak 18. However, the location of the satellite 10 at to can be over any predetermined location on an object having a mass sufficient to cause gradients in the gravitational field of the planet 12.

Referring to FIG. 3, the EM radar 24 is mounted on the satellite 10 and includes an electromagnetic image generator. The electromagnetic image generator has an antenna 40 arranged so that it is aimed at the mountain 16 as the satellite 10 passes over the mountain 16. A signal generator 42, or some other signal source, generates a signal. The signal is fed through a transmitter 44, fed through a circulator 46, and then fed to the antenna 40. In response to excitement by the signal, the antenna 40 radiates an electromagnetic signal toward the mountain 16. The electromagnetic signal is reflected off the mountain 16 and the reflected signal excites the antenna 40. From the antenna 40, the reflected signal is fed through the circulator 46 to a receiver 48. The reflected signal is then input to a processor 50.

There are two predetermined time delays in the circuit for the EM radar 24. The first time delay t_{td1} is the time for the signal-generator signal to travel from the signal generator 42 to the antenna 40, and the second time delay t_{td2} is the time required for the reflected signal to travel from the antenna 40 to the processor 50. Additionally, a clock 52 inputs a clock signal to the processor 50. The processor 50 controls the time that the signal generator 42 generates the signal-generator signal and feeds it to the transmitter 44.

The processor 50 also determines a second time value tᵣₜₙ, which is the time that the reflected signal is input into the processor 50. The processor 50 then determines the time, Δtₑₘ, it takes the electromagnetic signal to travel from the peak 20 of the mountain 16 to the antenna 40 of the EM radar 24. Δtₑₘ is equal to half the travel time of the electromagnetic signal from the antenna 40, to the mountain 16, and back to the antenna 40. Accordingly, the time that it takes for the electromagnetic signal to travel from the mountain peak 20 to the antenna 40 is calculated by the equation:

$$Δ {t}_{em} = \frac{{t}_{rtn} - {t}_{0} - {t}_{td2}}{2} \qquad ( 1 )$$

To insure that Δtₑₘ is accurately calculated, it is desirable that the distance the transmitted electromagnetic signal travels from the satellite 10 to the mountain peak 20 is substantially equal to the distance that the reflected electromagnetic signal travels from the mountain peak 20 to the satellite 10. Accordingly, the antenna 40 begins to transmit the electromagnetic signal at location slightly before the peak 20 and a time slightly before tₒ. One possible way to determine the exact location and time to begin transmitting the electromagnetic signal is by measuring the location of the satellite 10 at both the moment the electromagnetic signal is transmitted and at the moment that the reflect signal is received. These measurements can be made in an iterative process until the desired accuracy of measurements is achieved.

Although certain circuits and arrangements were disclosed in the foregoing descriptions of the EM radar 24 and the Doppler radar 22, it is to be understood that any apparatus and method for gathering the required data can be used. For example, the electronics in the EM radar can be merely a transmitter, a receiver, and a data collection device. The calculations for time intervals are then performed on other computing apparatuses. Additionally, there could be other circuits for generating signals and determining time shifts, or time delays. Additionally, the circuits in the EM radar and the Doppler radar will include other components that are know to those skilled in the art such as amplifiers, modulators, filters, analog to digital converts, and the like.

During the measurement experiment, as the satellite 10 travels along the path 14, it crosses over the peak 20 of the mountain 16 at a time t₀. As discussed above, the EM radar 24 begins to send a signal at time tₒ, and the Doppler radar 22 records the velocity of the satellite 10 at time tₒ. The time it takes for the electromagnetic signal to travel from the peak 20 of the mountain 16 to the antenna 40 of the EM radar 24 is Δtₑₘ. Accordingly:

$$Δ {t}_{em} = \frac{h}{c} \qquad ( 2 )$$

where c is the speed of light (3×10⁸ meters/s) and h is the height 5. Electromagnetic or radio frequency signals travel at the speed of light.

Similarly, the time it takes for the satellite 10 to sense the change in the gravitational field due to the mountain 16, which is the time it takes for the gravitational field to propagate from the mountain 16 to the satellite 24, is Δt_{g} . Accordingly:

$$Δ {t}_{g} = \frac{h}{{v}_{g}} \qquad ( 3 )$$

where v_{g} is the speed at which the variational gravitational field propagates and h is the height 5.

The satellite 10 will travel a certain distance while the electromagnetic radiation and gravitational field propagate to the satellite 10. Accordingly, Δtₑₘ, and Δt_{g} can be determined by measuring the positional displacement of the satellite 10. The satellite 10 will move total of distance:

Lₑₘ=v(t)Δtₑₘ (4)

during the time it takes for the electromagnetic signal reflected off the mountain peak 20 to reach the satellite 10, where Lₑₘ is the distance the satellite 10 travels and v(t) is the velocity of the satellite 10. Similarly, the satellite 10 will move a distance:

L_{g}=v(t)Δt_{g} (5)

during the time it takes for the gravitational field to propagate to the satellite 10, where L_{g} is the distance the satellite 10 travels and v(t) is the velocity of the satellite 10.

Given the mathematical relationships outlined in equations (2)-(5), the propagation speed for the variational gravitational field of the planet 12 can be derived to a proportional relationship as defined by the following equations. More specifically substituting the value of Lₑₘ from equation (4) into equation (5) gives:

$${L}_{g} = \frac{{L}_{em}}{Δ {t}_{em}} Δ {t}_{g} \qquad ( 6 )$$

Substituting the value of Δt_{g} from equation (3) into equation (6) gives:

$${L}_{g} = \frac{{L}_{em} h}{Δ {t}_{em} {v}_{g}} \qquad ( 7 )$$

Finally, substituting the value of Δtₑₘ from equation (2) into equation (7) gives:

$$\begin{matrix}{L}_{g} = \frac{{L}_{em} h}{\frac{h}{c} {v}_{g}} & ( 8 ) \\ or & \\ {v}_{g} = c \frac{{L}_{em}}{{L}_{g}} & ( 9 )\end{matrix}$$

This equation provides a way to determine the propagation rate of the variational gravitation field between the satellite and the Earth by measuring the distance Lₑₘ and L_{g}. Thus, for example, if Lₑₘ/L_{g} is 1000, then the variational gravitational field propagates 1000 times faster than the speed of light. If Lₑₘ/L_{g} is 10⁹, then the variational gravitational field propagates 1 billion times faster than the speed of light.

The distances for Lₑₘ and L_{g} can be calculated using equations (4) and (5) or can be measured. These distances can be measure using any type of accurate measuring system used to measure the position or satellite 10 that are known by those skilled in the art. Examples might include gyroscopic measuring systems, land-based radar systems, or any other navigational system.

Alternatively, one can view the analysis by comparing the time values Δtₑₘ and Δt_{g} . Substituting equations (4) and (5) into equation (8) gives:

$${v}_{g} = c \frac{Δ {t}_{em}}{Δ {t}_{g}} \qquad ( 10 )$$

If Δtₑₘ/Δt_{g} is 1000, then the variational gravitational field propagates 1000 times faster than the speed of light. If Δtₑₘ/Δt_{g} is 10⁹, then the variational gravitational field propagates 1 billion times faster than the speed of light. Accuracy can be verified by determining both the distance displacement (Lₑₘ and L_{g}) and time displacement (Δtₑₘ and Δt_{g} ), inserting these values into equations (8) and (9), respectively, and comparing the results.

There are many alternative embodiments, for example, one could measure time values or distance to determine the velocity of the gravity. Additionally, one could use many different types of instrumentation to measure various time lapses or intervals or to measure the distance the satellite 10 travels between predefined events as discussed herein.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A method of measuring the speed at which a variational gravitational field propagates, the gravitational field relating to a planet, the planet having an object, the object having sufficient mass to change the gravitational field, the method comprising:
moving a satellite in orbit around the planet so that it passes over the object;
determining the time interval Δt_{g} between a predetermined time and the moment that the velocity of the satellite changes due to a change in the gravitation field;
determining the time interval Ate, it takes an electromagnetic signal to travel from the object to the satellite, the electromagnetic signal beginning to travel at the predetermined time; and
calculating the speed of the gravitational field according to the equation:
$${v}_{g} = c \frac{Δ {t}_{em}}{Δ {t}_{g}}$$
where v_{g} is the speed at which the variational gravitational field travels and c is the speed of light.

2. The method of claim 1 wherein determining the time interval Δt_{g} includes measuring the speed of the satellite using a Doppler radar beginning at the predetermined time.

3. The method of claim 2 wherein determining the time interval Δtₑₘ includes transmitting an electromagnetic signal to the object and detecting the reflected signal at the satellite.

4. A method of measuring the speed at which a variational gravitational field propagates, the gravitational field relating to a planet, the planet having an object, the object having sufficient mass to change the gravitational field, the method comprising:
moving a satellite in orbit around the planet so that it passes over the object;
determining the distance L_{g} that a satellite travels from a predetermined position and a second position that coincides with the moment that the velocity of the satellite changes from the velocity that the satellite was traveling at the predetermined position due to a change in the gravitation field;
determining the distance Lₑₘ that the satellite travels from the predetermined position to a third position that coincides with the moment that an electromagnetic signal to completes travel from the object to the satellite; and
calculating the speed of the gravitational field according to the equation:
$${v}_{g} = c \frac{{L}_{em}}{{L}_{g}}$$
where v_{g} is the speed at which the gravitational field travels and c is the speed of light.

5. The method of claim 4 wherein determining the distance L_{g} includes measuring the position of the satellite.

6. The method of claim 4 wherein determining the distance Lₑₘ includes measuring the position of the satellite.
